(19) United States
(12) Patent Application Publication
(10) Pub. No.: US 2022/0061519 A1
(43) Pub. Date: Mar. 3, 2022

(54) INTERACTIVE TABLE

(71) Applicant: LITEMAX ELECTRONICS INC., New Taipei City (TW)

(72) Inventors: TIEN-TENG YANG, New Taipei City (TW); CHUN-HUNG CHEN, New Taipei City (TW)

(21) Appl. No.: 17/002,798

(22) Filed: Aug. 26, 2020

(51) Int. Cl. A47B 13/08; G06F 3/041; G06F 3/14; A47B 21/06

(52) U.S. Cl. CPC A47B 13/08; G06F 3/041; A47B 2021/066; A47B 21/06; A47B 2200/008; G06F 3/14

(57) ABSTRACT

An interactive table includes a main body, a tabletop portion and at least one support. The tabletop portion is disposed on the casing and electrically connected to the control unit. The tabletop portion includes a touch par and a display part, wherein the display part is disposed along a perimeter of the tabletop portion and surrounding the touch part. The support is connected to a surface of the casing opposite to the tabletop portion.

### BACKGROUND OF THE INVENTION

### 1. Field of the Invention

The present disclosure relates to an interactive table, and more particularly to an interactive table with enhanced display and touch functions.

### 2. Description of the Related Art

A display device is nowadays a common device in daily life, such as game boards, restaurant menus, and advertising bulletin boards, etc. However, the above-mentioned display devices are bulky and difficult to move, and thus users still need paper menus and paper maps to obtain the required information, which virtually causes a waste of resources. In order to solve the above problems and improve the convenience of use, the displayed information is integrated on a desktop used by the user, so that the user can obtain the information without leaving the seat. However, depending on the importance of the displayed information, some of the information may need to be presented with increased brightness or electronic dynamics in order to increase the convenience of information interpretation. In addition, after the user obtains the information, if the user's options can be fed back to the service provider in a touch-sensitive manner in real time, the interaction efficiency between the user and the service provider will be further improved.

### BRIEF SUMMARY OF THE INVENTION

It is an object of the present disclosure to provide an interactive table capable of dynamically displaying information required by a user on a tabletop portion and providing touch interaction, thereby increasing the convenience of information recognition and improving interaction efficiency.

To achieve at least the above object, the present disclosure provides an interactive table, including a main body, a tabletop portion and at least one support. The tabletop portion is disposed on the casing and electrically connected to the control unit. The tabletop portion includes a touch part and a display part, wherein the display part is disposed along a perimeter of the tabletop portion and surrounding the touch part. The support is connected to a surface of the casing opposite to the tabletop portion.

In an embodiment, the main body further includes a computing device and an expansion port, wherein the control unit is disposed in the computing device, and the computing device is plugged in the expansion port.

In an embodiment, the main body further includes a cover portion pivotally connected to the casing for opening and closing with respect to the casing, and the expansion port is disposed under the cover portion.

In an embodiment, the tabletop portion further includes a light emitting module disposed under the display part.

In an embodiment, the main body further includes a power unit and an electrical conducting wire, wherein the power unit is disposed in the casing and electrically connected to the control unit, and the electrical conducting wire is connected to the power unit and penetrates the surface of the casing. The display part includes a plurality of charging modules electrically connected to the power unit for charging an electronic device in a wired or wireless manner.

In an embodiment, the main body further includes a communication unit electrically connected to the control unit.

In an embodiment, the main body further includes a signal wire, an opening is formed on the surface of the casing, and the signal wire penetrates the opening to be connected to the control unit.

In an embodiment, the support includes a connection portion, a body portion and a stand portion. The connection portion is fixed on and parallel to the surface of the casing, the body portion is a cylindrical surface or a conical surface and connected between the connection portion and the stand portion, and the stand portion is a hollow cylinder and suitable for contacting ground.

In an embodiment, the interactive table further includes a stand connected inside the body portion.

In an embodiment, the interactive table further includes a plurality of supporting portions disposed along a perimeter of the casing and connected to the casing and the tabletop portion.

The interactive table of the present disclosure provides a user with information shown on the display part disposed at the perimeter of the interactive table, and the user can operate the touch part to feedback the options in real time to the service provider, thereby significantly improving the convenience of information access and interaction efficiency.

In order to further illustrate features and advantages of the present disclosure, the following embodiments are described in detail with reference to the accompanying drawings.

### BRIEF DESCRIPTION OF THE DRAWINGS

FIG. 1 is a schematic view showing an interactive table according to an embodiment of the present disclosure.

FIG. 2 is a schematic side view of the interactive table in FIG. 1.

FIG. 3 is a block diagram showing internal components of the interactive table in FIG. 1.

FIG. 4 is a top view of the tabletop portion of FIG. 1.

FIG. 5 is a schematic bottom view of the interactive table in FIG. 1.

FIG. 6 is a partial enlarged schematic diagram of the interactive table of FIG. 1.

FIG. 7 is a partial enlarged schematic diagram of an interactive table according to another embodiment of the present disclosure.

### DETAILED DESCRIPTION OF THE INVENTION

To facilitate understanding of the object, characteristics and effects of the present disclosure, embodiments together with the attached drawings for the detailed description of the present disclosure are provided. The direction terms mentioned in the following embodiments, for example: up, down, left, right, front, back, etc., are only for the directions referring to the drawings. Therefore, the directional terms used are for illustration, not for limiting the present disclosure. In addition, in the following embodiments, the same or similar elements are indicated by the same reference numerals.

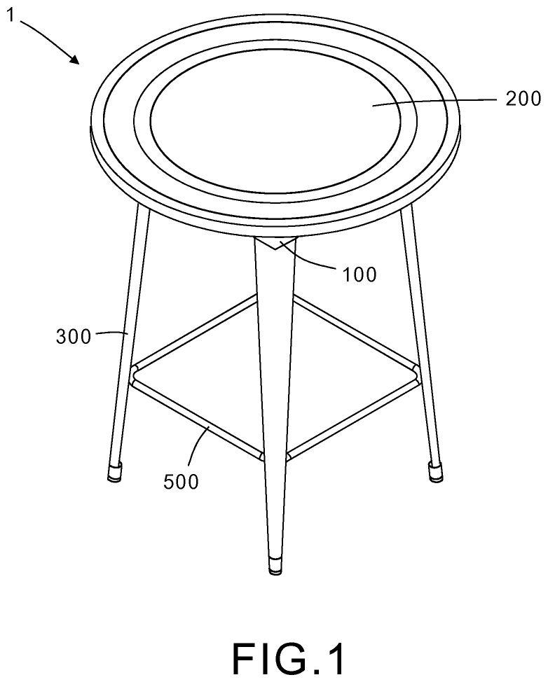

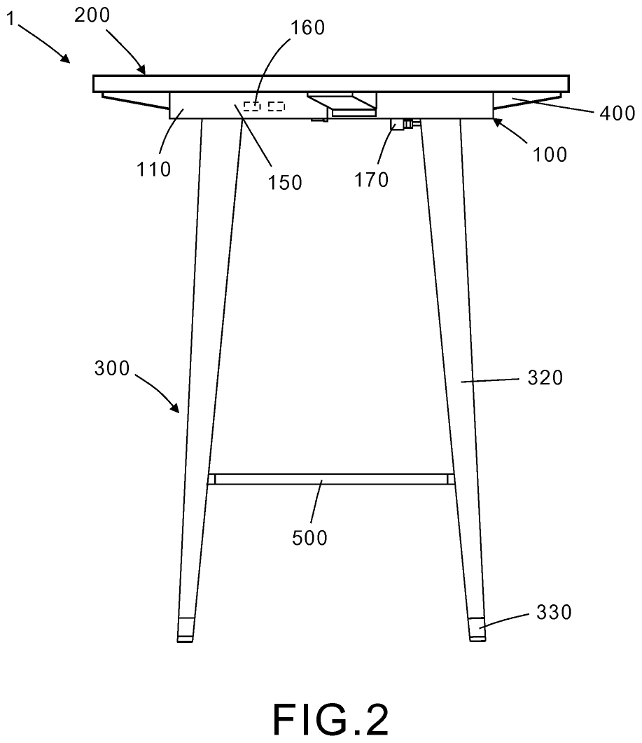

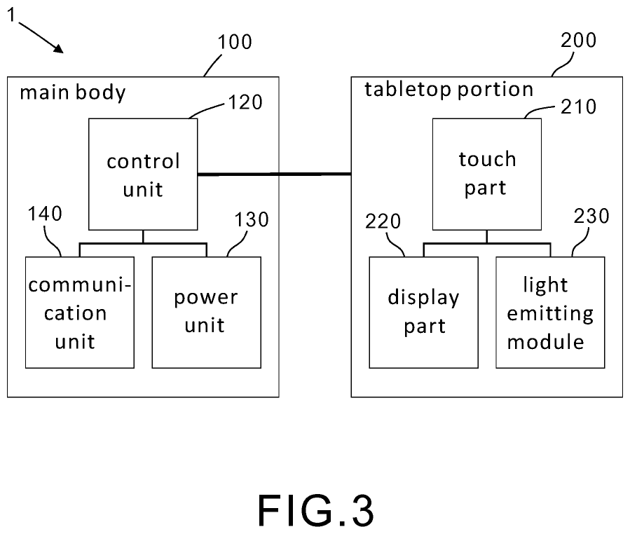

Please refer to FIG. 1 to FIG. 3. FIG. 1 is a schematic view showing an interactive table according to an embodiment of the present disclosure, FIG. 2 is a schematic side view of the interactive table in FIG. 1, and FIG. 3 is a block diagram showing internal components of the interactive table in FIG. 1. In this embodiment, an interactive table 1 includes a main body 100, a tabletop portion 200, at least one support 300, a plurality of supporting portions 400 and a stand 500. The main body 100 includes a casing 110, a control unit 120, a power unit 130 and a communication unit 140, wherein the control unit 120 can be a programmable controller or a central processor, the power unit 130 can a battery or a capacitor, and the communication unit 140 can be a wireless radio frequency transceiver or ethernet card. The control unit 120, the power unit 130 and the communication unit 140 are disposed in the casing 110, and the power unit 130 and the communication unit 140 are electrically connected to the control unit 120. The tabletop portion 200 is disposed on the casing 110 and electrically connected to the control unit 120. The tabletop portion 200 includes a touch part 210, a display part 220 and a light emitting module 230. The support 300 is connected to a surface of the casing 110 opposite to the tabletop portion 200. The supporting portions 400 are disposed along a perimeter of the casing 110 and connected to the casing 110 and the tabletop portion 200. The stand 500 is connected to the support 300.

The interactive table 1 is used for providing a user with information, such as menu items, gambling items, visual patterns presented by gaming machines or directions on maps, etc. More specifically, in this embodiment, the display part 220 can include a display panel or a video output unit, wherein the display panel can be a liquid crystal panel, a plasma panel, a diode panel or an acrylic panel with static patterns. In the case that a service provider needs to present information to a user, the information to be presented can be prestored in the control unit 120 or transmitted to the communication unit 140 in the form of packets, the information is transmitted to the control unit 120 upon the information is received by the communication unit 140, the information is integrated by the control unit 120 into a form acceptable to the display unit 220 and transmitted by the control unit 120 to the display unit 220, and then the display unit 220 is controlled by the control unit 120 to display the information. As a result, the user can be provided with static or dynamic information. After the information is output, the control unit 120 can also real time control the display 220 to stop outputting or switch the information to other items, such that the interactive table 1 has many display functions.

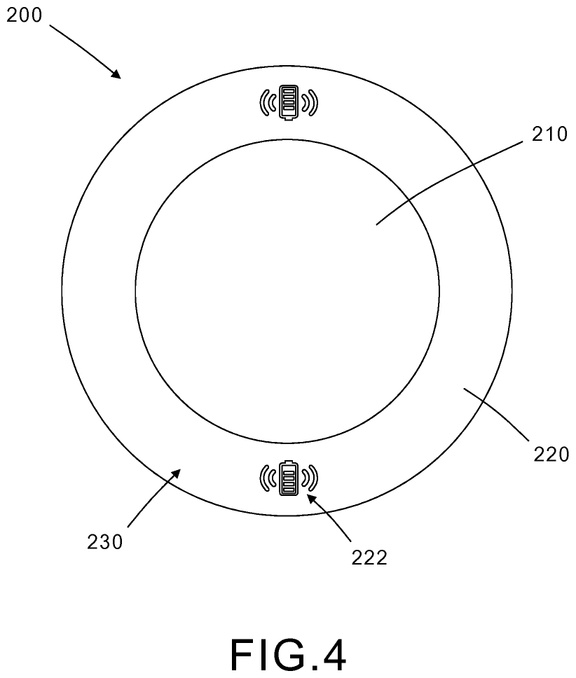

Referring to FIG. 4, FIG. 4 is a top view of the tabletop portion of FIG. 1. Furthermore, the display part 220 is arranged along a perimeter of the tabletop portion 200 and surrounds the touch part 210. Therefore, while the information is display on the display part 220, the information can move along the perimeter of the tabletop portion 200, such that each user sitting around the table can get the same information and reading frequency. On the other hand, as shown in FIG. 4, the light emitting module 230 is disposed under the display part 220. When the display panel of the display unit 220 has insufficient luminosity or has no light source, the control unit 120 can control the light emitting module 230 to emit light with a corresponding intensity to enhance the user's visual experience.

In this embodiment, the touch part 210 is disposed in the center of the tabletop portion 200 and surrounded by the display part 220. When the user receives the above-mentioned information displayed by the display part 220, the user can operate the touch unit 210 by pressing, clicking, sliding, etc. for transmitting the option selected by the user to the control unit 120. After receiving the selected option, the control unit 120 controls the display part 220 to display the information corresponding to the selected option. Alternatively, the communication unit 130 transmits the content of the selected option to the service provider in a wired or wireless manner, thereby achieving an interactive effect.

As shown in FIG. 4, the display part 220 includes a plurality of charging modules 222, wherein the charging modules 222 are electrically connected to the power unit 130. In this embodiment, there are two charging modules presented on the display part 220 as an image for the user. The user can place an electronic device, such as a smart phone, tablet computer or smart watch, on the area of the display part 220 that shows the image, and then the electronic device can be charged wirelessly by the charging module 222. In another embodiment, the amount of the charging modules can be one or more, and the charging can be conducted in a wired charging stand or an external power supply, which provides users with a wired connection to charge the electronic device.

In the embodiment of the present disclosure, the display part 220 is disposed to surround the touch part 210. In another embodiment, the display part 220 can also disposed directly above the touch part 210. In other words, the display part 220 may also have the function of touch operation, which also allows the user to have more flexibility in using the interactive table 1. In addition to receiving output information from the service provider and transmitting the options selected by the user to the service provider, the communication unit 140 can also update the required programs or software for the interactive table 1 from the server of the service provider in a wired or wireless manner, so as to meet different display and interaction requirements.

Referring to FIG. 2, the main body 100 further includes a cover portion 150 and an expansion port 160 for a computing device to be plugged in. In addition, the main body 100 includes an electrical conducting wire 170 connected to the power unit 130 and penetrating the surface of the casing 110 opposite to the tabletop portion 200. The service provider can connect an external power supply through the electrical conducting wire 170 when using the interactive table 1, and distribute the obtained power to the control unit 120, the communication unit 140, and various components of the tabletop portion 200 through the power unit 130. Alternatively, a power storage device (not shown) can be configured inside the power unit 130. When the interactive table 1 is not in use, an external power source can be connected to charge the power storage device through the electrical conducting wire 170, and when the user needs to use the interactive table 1, the interactive table 1 can be moved to the surrounding environment without sockets, such that the interactive table 1 of the present disclosure has more flexibility in use.

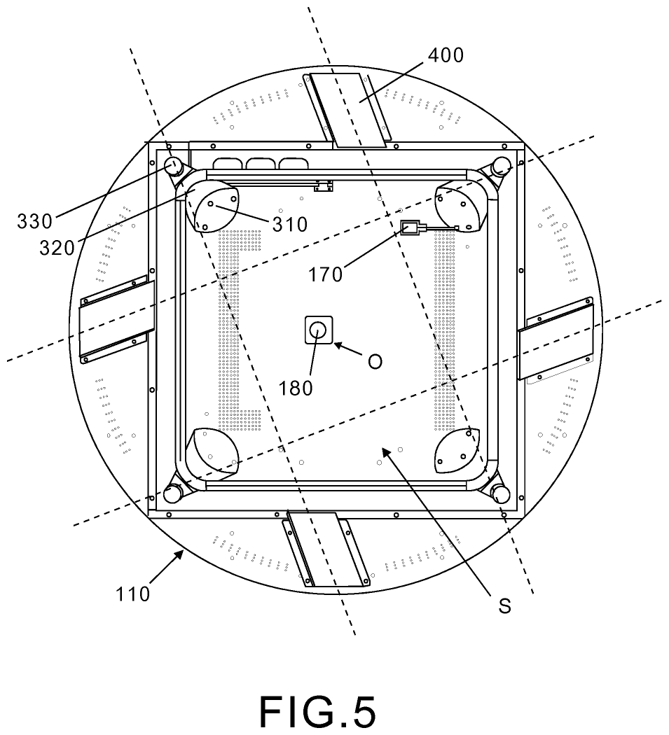

Referring FIG. 2 and FIG. 5, FIG. 5 is a schematic bottom view of the interactive table in FIG. 1. As shown in FIG. 5, the main body 100 further includes a signal wire 180, an opening O is formed on the surface S of the casing 110 opposite to the tabletop portion 200, and the signal wire 180 passes the opening O and connected to the control unit 120. The signal wire 180 performs two-way information transmission between the interactive table 1 and the server of the service provider in a wired manner, or updates the software of the interactive table 1. Furthermore, in another embodiment, the opening O can be directly formed on the surface S for the signal wire 180 to pass through. In another embodiment, a wire cover plate may be disposed on the opening O, the signal wires 180 is disposed on the surface S through a hole of the wire cover plate, and the present disclosure is not limited thereto.

In this embodiment, there are four supports 300 arranged at the four corners of the main body 100 at equal intervals. Each support 300 includes a connection portion 310, a body portion 320 and a stand portion 330, wherein the connection portion 310 is fixed on and parallel to the surface S of the casing 110 via a fastening element such as a screws, a rivet or the like; the body portion 320 is a cylindrical surface or a conical surface and connected between the connection portion 310 and the stand portion 330; and the stand portion 330 is a hollow cylinder and suitable for contacting ground. The stand 500 is connected inside the body portion 320. With this configuration, the support 300 has a large contact area with the surface S through the connection part 310, so as to be tightly fixed on the main body 100. The body portion 320 and the stand part 330 are both sheet-like structures, so as to significantly reduce the weight of the interactive table 1 while maintaining the support strength. The arrangement of the stand 500 can also be used for placement of the user's feet, so as to improve the comfort for the user. When the interactive table 1 needs to change the support form or the number of the supports 300, it can be replaced at any time by only removing the fastening elements on the connection portion 310. For example, when there is only one support 300, the support is disposed in the center of the casing; and when there are two supports 300, the supports 300 can be arranged at two opposite corners of the casing 110, and the number of stand parts 330 is increased for each support 300 to improve stability, which is quite simple and convenient.

As shown in FIG. 2 and FIG. 5, the projection shape of the supporting portion 400 on the bottom surface is a parallelogram, and the side surface of the supporting portion 400 is a wedge shape. This design takes into account the different load conditions of the bottom and the sides of the tabletop portion 200. As shown in FIG. 5, in this embodiment, the extension lines of the four supporting portions 400 are parallel in pairs, and none of them passes through other supporting portions 400. This configuration can evenly and stably support the load that may be generated by the object carried on the tabletop portion 200. From the side view, the closer to the center of the tabletop portion 200, the greater the shear force caused by the weight of the tabletop portion 200. Therefore, a thicker structure is required at the junction of the tabletop portion 200 and the casing 110 to withstand the increasing shear and torque loads.

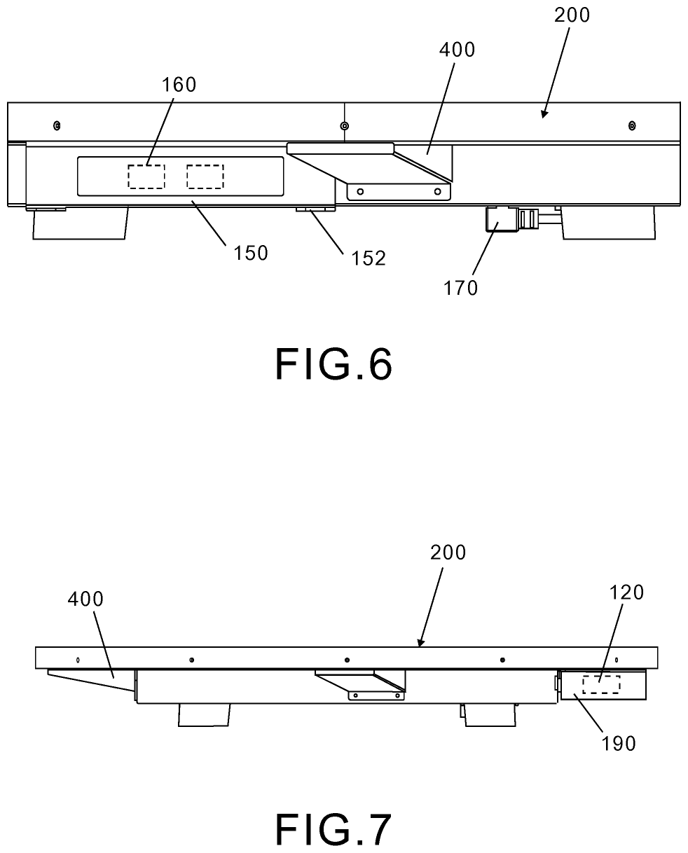

Referring FIG. 6, FIG. 6 is a partial enlarged schematic diagram of the interactive table of FIG. 1. As described above, the main body 100 includes the cover portion 150 and the expansion port 160, wherein the cover portion 150 pivotally connected to the casing 110 via a pivoting element 152 such as a hinge or the like for opening and closing with respect to the casing 110, and the expansion port 160 is disposed under the cover portion 150. When the interactive table 1 needs to install other software, the user can open the cover portion 150 pivotally connected to the casing 110, and plug the software-installed medium such as USB hard disk into the expansion port 160. As a result, the interactive table 1 can download the required software from the software-installed medium, thereby increasing the functions of the interactive table 1. After use, the user can remove the computing device and cover the cover 150 to prevent foreign matter such as dust from entering the expansion port 160.

Referring to FIG. 7, FIG. 7 is a partial enlarged schematic diagram of an interactive table according to another embodiment of the present disclosure. In this embodiment, the main body 100 further includes a computing device 190, wherein the computing device 190 is for example a computer, and the control unit 120 is disposed in the computing device 190. Specifically, if the software to be executed requires more powerful computing functions, the user can plug the computing device 190 into the expansion port 160, and the control unit 120 built in the computing device 190 assists the interactive table 1 in computing, thereby significantly improve the computing efficiency of the interactive table 1 and expanding the applications of the interactive table 1.

While the present disclosure has been described by means of specific embodiments, numerous modifications and variations could be made thereto by those skilled in the art without departing from the scope and spirit of the present disclosure set forth in the claims.

What is claimed is:

1. An interactive table, comprising:
a main body, including a casing and a control unit;
a tabletop portion, disposed on the casing and electrically connected to the control unit, wherein the tabletop portion includes:
a touch part; and
a display part, disposed along a perimeter of the tabletop portion and surrounding the touch part; and
at least one support, connected to a surface of the casing opposite to the tabletop portion.

2. The interactive table according to claim 1, wherein the main body further comprises a computing device and an expansion port, the control unit is disposed in the computing device, and the computing device is plugged in the expansion port.

3. The interactive table according to claim 1, wherein the main body further comprises a cover portion pivotally connected to the casing for opening and closing with respect to the casing, and the expansion port is disposed under the cover portion.

4. The interactive table according to claim 1, wherein the tabletop portion further comprises a light emitting module disposed under the display part.

5. The interactive table according to claim 1, wherein the main body further comprises a power unit and an electrical conducting wire, the power unit is disposed in the casing and electrically connected to the control unit, the electrical conducting wire is connected to the power unit and penetrates the surface of the casing, the display part includes a plurality of charging modules electrically connected to the power unit for charging an electronic device in a wired or wireless manner.

6. The interactive table according to claim 1, wherein the main body further comprises a communication unit electrically connected to the control unit.

7. The interactive table according to claim 1, wherein the main body further comprises a signal wire, an opening is formed on the surface of the casing, and the signal wire penetrates the opening to be connected to the control unit.

8. The interactive table according to claim 1, wherein the at least one support comprises a connection portion, a body portion and a stand portion, the connection portion is fixed on and parallel to the surface of the casing, the body portion is a cylindrical surface or a conical surface and connected between the connection portion and the stand portion, and the stand portion is a hollow cylinder and suitable for contacting ground.

9. The interactive table according to claim 1, further comprising a stand connected inside the body portion.

10. The interactive table according to claim 1, further comprising a plurality of supporting portions disposed along a perimeter of the casing and connected to the casing and the tabletop portion.
